(19) United States
(12) Patent Application Publication
(10) Pub. No.: US 2022/0180541 A1
(43) Pub. Date: Jun. 9, 2022

(54) THREE-DIMENSIONAL COORDINATE SCANNER

(71) Applicant: FARO Technologies, Inc., Lake Mary, FL (US)

(72) Inventors: Oliver Zweigle, Stuttgart (DE); Mark Brenner, Asperg (DE); Aleksej Frank, Kornwestheim (DE); Ahmad Ramadneh, Kornwestheim (DE); Mufassar Waheed, Ditzingen (DE); Muhammad Umair Tahir, Stuttgart (DE)

(21) Appl. No.: 17/457,119

(22) Filed: Dec. 1, 2021

Related U.S. Application Data
(60) Provisional application No. 63/122,189, filed on Dec. 7, 2020.

(51) Int. Cl. G06T 7/521; G06T 7/579; H04N 5/225; G06T 7/35

(52) U.S. Cl. CPC G06T 7/521; G06T 7/579; G06T 2207/10024; G06T 7/35; G06T 2207/10028; H04N 5/2252

(57) ABSTRACT

A three dimensional coordinate measurement device and method of measuring is provided. The device including a housing having a first axis and a second axis. A first depth camera is coupled to the housing, the first depth camera having a first optical axis aligned with the first axis. A second depth camera is coupled to the housing, the second depth camera having a second optical axis disposed on a first angle relative to the first axis. A third depth camera is coupled to the housing, the third depth camera having a third optical axis disposed on a second angle relative to the first axis, the second angle being different than the first angle. A rotational device is coupled to rotate the housing about the second axis.

### CROSS REFERENCE TO RELATED APPLICATIONS

This application claims the benefit of U.S. Provisional Application Ser. No. 63/122,189, filed Dec. 7, 2020, the entire disclosure of which is incorporated herein by reference.

### BACKGROUND

The subject matter disclosed herein relates to a three-dimensional coordinate scanner, and in particular to a portable coordinate measurement device.

A 3D imager is a portable device having a projector that projects light patterns on the surface of an object to be scanned. Typically, the projector emits a coded or uncoded pattern. One or more cameras, having predetermined positions and alignment relative to the projector, record images of a light pattern on the surface of an object. The three-dimensional coordinates of elements in the light pattern can be determined by trigonometric methods, such as by using epipolar geometry.

Other types of devices may also be used to measure 3D coordinates, such as those that use time-of-flight techniques (e.g. laser trackers, laser scanners, time-of-flight cameras, etc.). These devices emit a light beam and measure the amount of time it takes for light to travel to the surface and return to the device to determine the distance. Typically, the time-of-flight scanner is stationary and includes mechanisms to rotate about two orthogonal axes to direct the light beam in a direction. By knowing the distance and the two angles, 3D coordinates may be determined.

Typically, the measurement of 3D coordinates is performed while the measurement device is stationary to provide a desired level of accuracy. Where the three-dimensional scanner is moved during data acquisition, an additional device, such as a two-dimensional scanner is used to track the position of the 3D scanning device. It should be appreciated that this increases the cost and complexity of 3D coordinate acquisition while moving.

Accordingly, while existing 3D coordinate measurement devices are suitable for their intended purposes the need for improvement remains, particularly in providing a three-dimensional scanner having the features described herein.

### BRIEF DESCRIPTION

According to one aspect of the disclosure a three dimensional coordinate measurement device is provided. The device including a housing having a first axis and a second axis. A first depth camera is coupled to the housing, the first depth camera having a first optical axis aligned with the first axis. A second depth camera is coupled to the housing, the second depth camera having a second optical axis disposed on a first angle relative to the first axis. A third depth camera is coupled to the housing, the third depth camera having a third optical axis disposed on a second angle relative to the first axis, the second angle being different than the first angle. A rotational device is coupled to rotate the housing about the second axis.

In addition to one or more of the features described herein, or as an alternative, further embodiments of the device may include one or more processors operably coupled to the first depth camera, the second depth camera, and the third depth camera, the one or more processors being configured to receive a first image data from the first depth camera, a second image data from the second depth camera, and a third image data from the third depth camera. In addition to one or more of the features described herein, or as an alternative, further embodiments of the device may include the first image data, the second image data, and the third image data each having an image and distance data associated with the image. In addition to one or more of the features described herein, or as an alternative, further embodiments of the device may include an encoder operably coupled to the motor and configured transmit an angle signal to the one or more processors indicating an angle of the motor about the second axis.

In addition to one or more of the features described herein, or as an alternative, further embodiments of the device may include the one or more processors being operable to determine three dimensional coordinates of a plurality of points on surfaces in an environment based at least in part on the first image data, the second image data, the third image data, and the angle signal. In addition to one or more of the features described herein, or as an alternative, further embodiments of the device may include the one or more processors being operable to assign color data to each of the three-dimensional coordinates based on at least one of the first image data, the second image data and the third image data.

In addition to one or more of the features described herein, or as an alternative, further embodiments of the device may include the one or more processors being operable to register the three dimensional coordinates into a common coordinate frame of reference. In addition to one or more of the features described herein, or as an alternative, further embodiments of the device may include the registration being performed based at least in part using simultaneous localization and mapping. In addition to one or more of the features described herein, or as an alternative, further embodiments of the device may include an inertial measurement unit operably coupled to the housing, wherein the registration is further based at least in part on one or more movement signals from the inertial measurement unit.

In addition to one or more of the features described herein, or as an alternative, further embodiments of the device may include the first depth camera, the second depth camera, and the third depth camera measure distance being based at least in part on the time of flight of light. In addition to one or more of the features described herein, or as an alternative, further embodiments of the device may include the first depth camera, the second depth camera, and the third depth camera each having a first photosensitive array and a second photosensitive array, the distance measured by the first depth camera, the second depth camera, and the third depth camera is based at least in part on images acquired by the first photosensitive array, the second photosensitive array, and a baseline distance between the first photosensitive array and the second photosensitive array. In addition to one or more of the features described herein, or as an alternative, further embodiments of the device may include the first depth camera, the second depth camera, and the third depth camera measuring distance based on a projection of a structure light pattern.

According to another aspect of the disclosure a method of measuring three-dimensional coordinates in the environment is provided. The method including rotating a scanning device about a first axis, the scanning device having a first depth camera, a second depth camera, and a third depth camera, the first depth camera having a first optical axis aligned with a second axis, the second depth camera having a second optical axis disposed on a first angle relative to the second axis, and the third depth camera having a third optical axis disposed on a second angle relative to the second axis. A first image data is acquired with the first depth camera. A second image data is acquired with the second depth camera. A third image data is acquired with the third depth camera. determining three-dimensional coordinates of points on surfaces in the environment based at least in part on the first image data, the second image data, the third image data, and an angle of the scanning device about the first axis.

In addition to one or more of the features described herein, or as an alternative, further embodiments of the method may include the acquisition of the first image data, second image data, and third image data are performed simultaneously. In addition to one or more of the features described herein, or as an alternative, further embodiments of the method may include recording a time data when the first image data, second image data, and third image data are acquired. In addition to one or more of the features described herein, or as an alternative, further embodiments of the method may include registering the three-dimensional coordinates in a common coordinate frame of reference. In addition to one or more of the features described herein, or as an alternative, further embodiments of the method may include the registration of the three-dimensional coordinates being based at least in part on a movement signal from an inertial measurement unit operably coupled to the scanning device.

In addition to one or more of the features described herein, or as an alternative, further embodiments of the method may include assigning a color to each of the three-dimensional coordinates based at least in part on one of the first image data, the second image data, and the third image data. In addition to one or more of the features described herein, or as an alternative, further embodiments of the method may include the first image data, the second image data, and the third image data is based at least in part on a time of flight of light. In addition to one or more of the features described herein, or as an alternative, further embodiments of the method may include projecting a structured light pattern with each of the first depth camera, the second depth camera, and the third depth camera.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a perspective view of a three dimensional coordinate scanner in accordance with an embodiment of the disclosure;

FIG. 1B is a side view of the coordinate scanner of FIG. 1A, the opposite side being a mirror image thereof;

FIG. 1C is a top view of the coordinate scanner of FIG. 1A;

FIG. 1D is a bottom view of the coordinate scanner of FIG. 1A;

FIG. 1E is a first end view of the coordinate scanner of FIG. 1A;

FIG. 1F is a second end view of the coordinate scanner of FIG. 1A;

FIG. 2A is a perspective view of the coordinate scanner of FIG. 1A with a handle attached;

FIG. 2B is a schematic sectional view of the coordinate scanner of FIG. 2A;

FIG. 3 is a side view of the coordinate scanner of FIG. 1A coupled to a stationary fixture;

FIG. 4 is a block diagram of the coordinate scanner of FIG. 1A;

FIG. 5 is a schematic illustration of the coordinate scanner of FIG. 1A showing the field of view of the LIDAR cameras; and

FIG. 6 is a block diagram illustrating a method operating the coordinate scanner of FIG. 1A.

The detailed description explains embodiments of the disclosure, together with advantages and features, by way of example with reference to the drawings.

### DETAILED DESCRIPTION

Embodiments of the present disclosure are directed to a low cost three dimensional scanner that is easily movable within an environment.

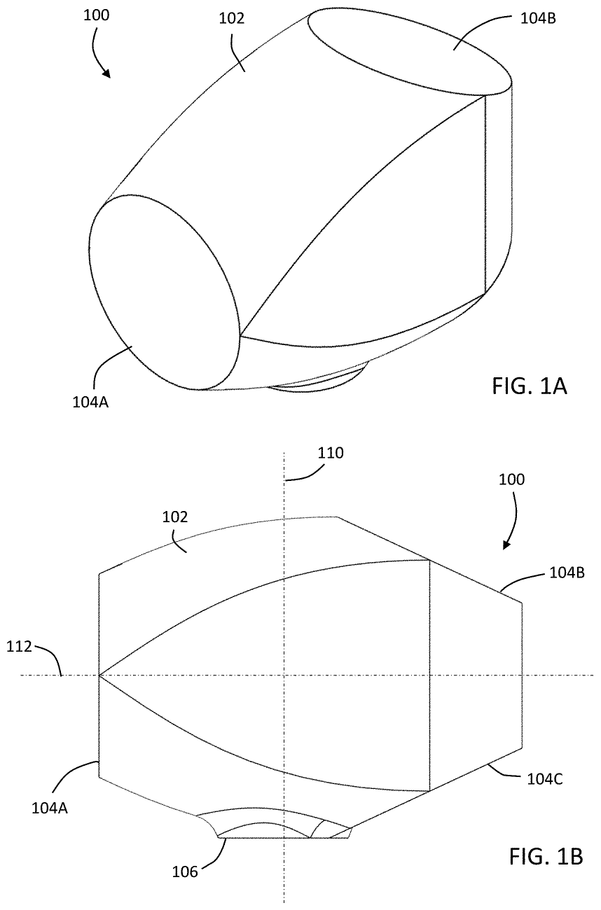

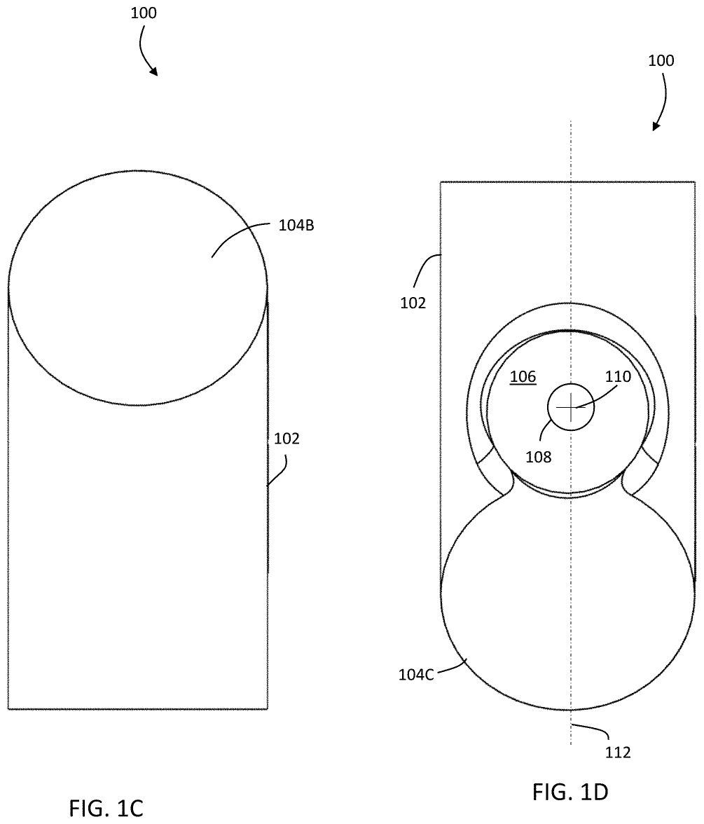

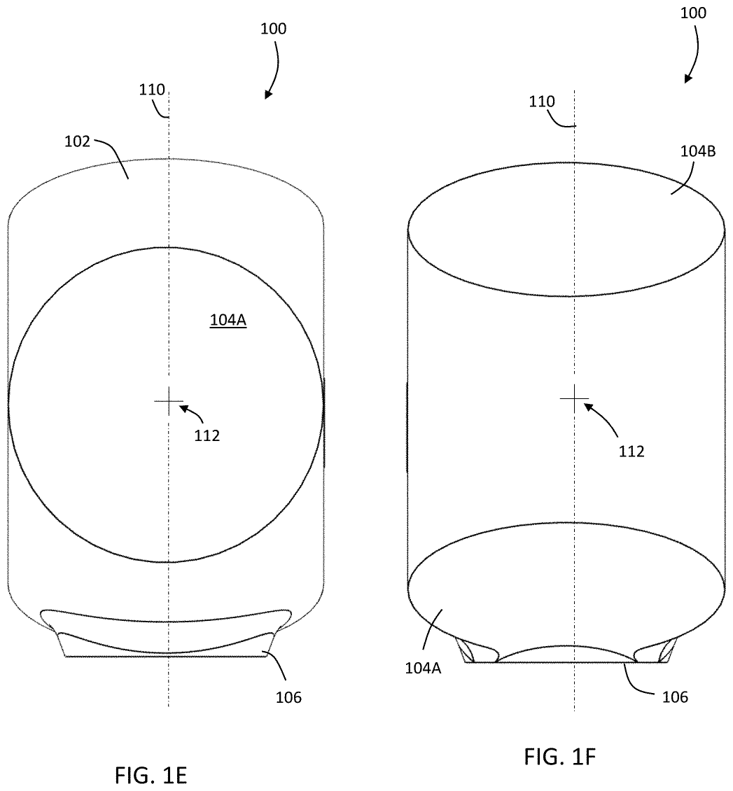

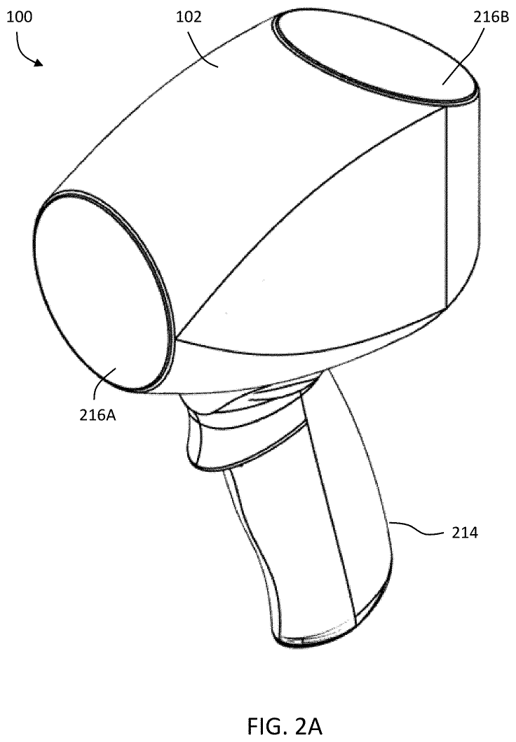

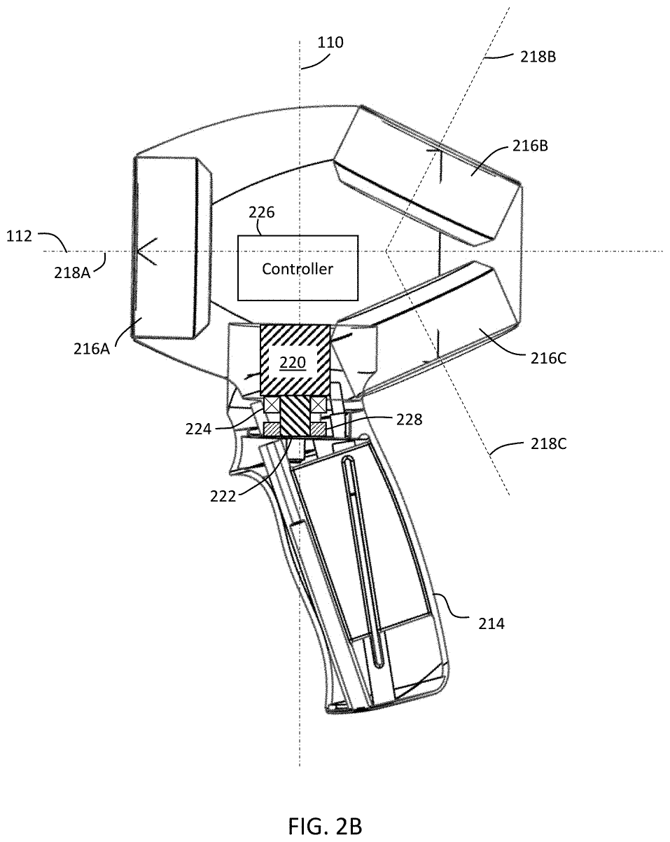

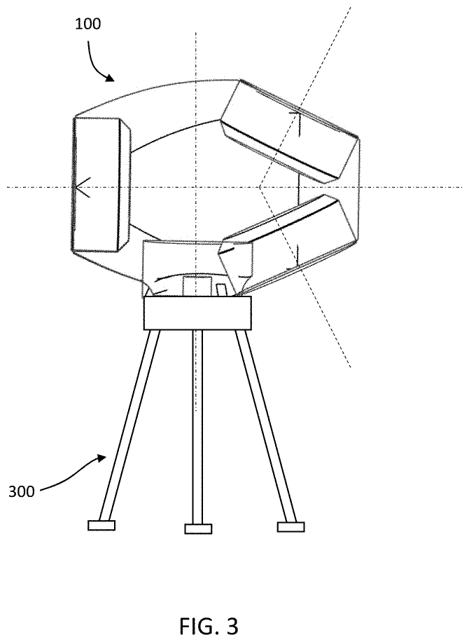

Referring now to FIGS. 1A-1F, an embodiment of a three-dimensional scanner 100. The scanner 100 includes a housing 102 having a plurality of apertures 104A, 104B, 104C. The housing 102 includes a base portion 106. In some embodiments, the base portion includes an attachment element 108 that may be used to couple the housing 102 to an accessory, such as a handle 214 (FIG. 2A), a stationary fixture such as a tripod 300 (FIG. 3), or a mobile platform for example. In an embodiment the attachment element 108 may be the same as that described in commonly owned U.S. Patent Application Ser. No. 62/958,989 entitled “Click Fit Mount Adapter” filed Jan. 9, 2020, the contents of which are incorporated by reference herein.

In the illustrated embodiment, the scanner 100 includes a first or horizontal axis 110 that extends through and is coaxial with the center of the aperture 104A. In the illustrated embodiment the scanner 100 further includes a second of vertical axis 112 that extends through the center of and is coaxial with the base portion 106, or the attachment element 108. In an embodiment, the intersection point of the axes 110, 112 is equidistant from the centers of the apertures 104A, 104B, 104C.

Disposed within the housing are a plurality of depth cameras 216A, 216B, 216C. The depth cameras 216A, 216B, 216C are configured to acquire an image, such as a color image for example, of the environment that includes depth or distance information for each pixel of the camera's photosensitive array. In an embodiment, the depth cameras 216A, 216B, 216C are LIDAR cameras that emit a beam of light that is scanned over the field of view of the camera and determine the distance based at least in part on the time of flight of the beam of light. In an embodiment, the depth cameras 216A, 216B, 216C are a model RealSense L515 LiDAR camera manufactured by Intel Corporation of Santa Clara, Calif., USA.

It should be appreciated that while embodiments herein may describe the depth cameras 216A, 216B, 216C as being a LiDAR type of depth camera. However, the claims should not be so limited. In other embodiments, other types of depth cameras may be used, such as a depth camera having a pair of spaced apart image sensors having a fixed predetermined baseline distance therebetween. In still other embodiments, the depth camera may emit a structured light pattern and determine the distance based at least in part on an image of the structured light pattern on a surface.

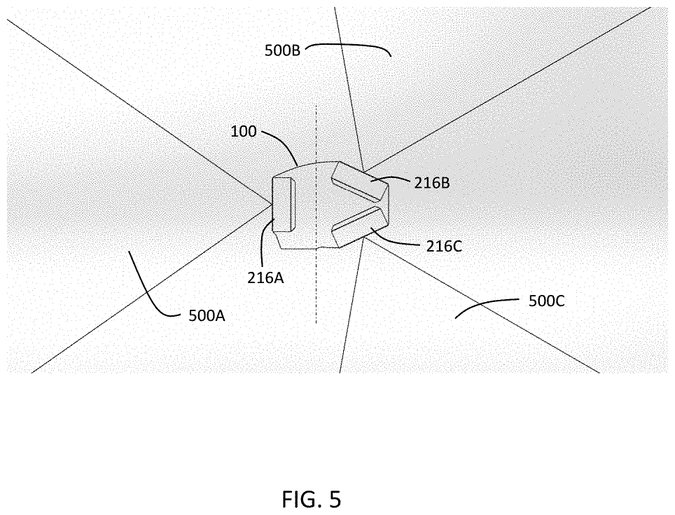

Each of the depth cameras 216A, 216B, 216C has an optical axis 218A, 218B, 218C that extends through the apertures 104A, 104B, 10C respectively. In the illustrated embodiment, the optical axis 218A is coaxial with the axis 112, and the optical axes 218B, 218C are disposed on an angle relative to the axis 112. In an embodiment, the axes 218B, 218C are symmetrically arranged on opposite sides of the axis 112. As shown in FIG. 5, each of the depth cameras 216A, 216B, 216C have a field of view 500A, 500B, 500C. In an embodiment, the fields of view 500A, 500B, 500C do not overlap. However, as discussed herein, in some embodiments due to the rotation of the housing 102 about the axis 110, coordinate measurements in a volume about the coordinate scanner may be measured without having occlusions when the coordinate scanner is moved through the environment.

In an embodiment, the scanner 100 may further include a rotational device, such as motor 220 (FIG. 2B), that is coupled to the housing 102. The motor 220 includes a shaft 222 that extends and couples to either the handle 214 or the fixture/tripod 300. One or more bearings 224 are arranged to allow the motor 220 to rotate the housing 102 about the axis 110. It should be appreciated that configuration of the motor 220, the shaft 222 and the bearings 224 in the illustrated embodiment is for example purposes and the claims should not be so limited. In other embodiments, the motor 220 may be disposed in the handle 214 or fixture/tripod 300 and shaft 224 is coupled to the housing 102. An angle sensor, such as rotary encoder 228 for example, may be provided for measuring the rotational angle of the housing 102 relative to the handle 214 or fixture/tripod 400.

In an embodiment, the interface between the housing 102 and the handle 214 or fixture/tripod 300 may include an electrical interface that allows for transmission of electrical power and/or electrical signals between the housing 102 and the stationary (relative to the housing) handle 214 and/or fixture/tripod 300. In an embodiment, the electrical interface may include one or more slip-ring members.

The scanner 100 may further include a controller 226 that is coupled for communication or electrically coupled to the depth cameras 216A, 216B, 216C, encoder 228, and the motor 220. In an embodiment, the controller 226 may be disposed within the housing 102, or may be external to the housing 102, such as on a mobile computing device, such as a wearable computing device for example. When the controller 226 is external to the housing 102, the controller 226 may be coupled to communicate with the depth cameras 216A, 216B, 216C, encoder 228, and the motor 220 via a wired (e.g. USB) or wireless (e.g. IEEE 802.11 or IEEE 802.15.1) connection. In an embodiment, the function controller 226 may be performed on a mobile cellular phone. It should be appreciated that embodiments where the scanner 100 includes a handle 214, the handle 214 may include electrical connections, or ports, that allow the scanner 100 to be electrically coupled to an external device or power source.

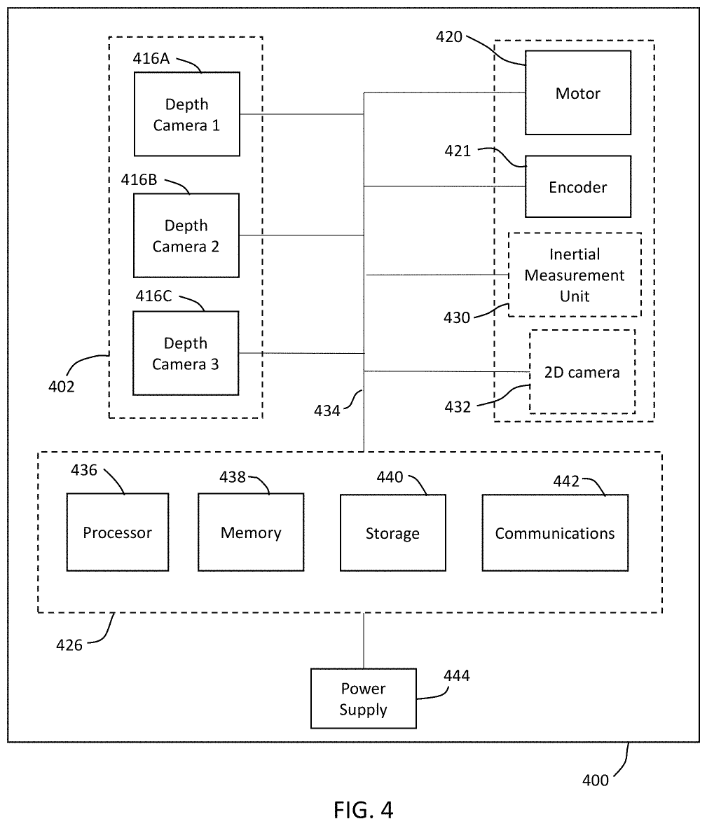

Referring now to FIG. 4, a block diagram of a scanner 400 is shown. In this embodiment, scanner 400 includes a plurality of depth cameras 416A, 416B, 416C that are disposed in a housing 402. In an embodiment, the depth cameras 416A, 416B, 416C may be arranged in the housing 402 in the same manner as described with respect to FIG. 1A-2B. The depth cameras 416A, 416B, 416C may be the same as cameras 216A, 216B, 216C described herein.

The scanner 400 further includes a motor 420 that is configured to rotate the housing 402 about an axis in a similar manner to motor 220 described with respect to FIGS. 1A-2B. The rotational angle of the motor 220 is measured by an angle sensor or rotary encoder 421. In an embodiment, an optional internal measurement unit 430 is provided. As used herein, an inertial measurement unit (IMU) 430 is a device that includes a plurality of sensors, such as but not limited to accelerometers, gyroscopes, and magnetometers for example. The IMU 430 is configured to output one or more signals indicating a movement (translational and/or rotational) of the housing 402. In an embodiment, the scanner 400 may further include an optional two-dimensional (2D) camera 432.

As used herein a 2D camera acquires an image without depth information. In an embodiment, the 2D camera may include a fisheye lens allowing for acquisition of an image having a field of view over 180 degrees. In an embodiment, the 2D camera may be integrated into the housing 402, such as along the sides of the housing 402. The activation of the 2D camera may be performed using a mobile computing device. In an embodiment, the position tracking of the scanner 400 is being performed continuously. Allowing for the x, y, z coordinate data of the scanner 400 to be associated with the image acquired by the 2D camera 432. In another embodiment, the 2D camera is separate (e.g. mounted to a stationary tripod, or mounted on the scanner operator) from the scanner 400 and is connected to the controller 426 via a wireless connection.

The depth cameras 416A, 416B, 416C, motor 420, encoder 421, IMU 430, and 2D camera 432 are coupled to communicate with a controller 426 such as by data transmission media 434. Data transmission media 434 includes, but is not limited to, twisted pair wiring, coaxial cable, and fiber optic cable. Data transmission media 434 also includes, but is not limited to, wireless, radio and infrared signal transmission systems. It should be appreciated that the controller 426 may be co-located with the depth cameras 416A, 416B, 416C, such as in housing 402, or may be remotely located, such as in a wearable computing device (e.g. a belt computer), a mobile cellular phone, a tablet computer, a laptop computer, or a desktop computer. It should be appreciated that the functionality described herein to the controller 426 may be distributed between multiple computing devices without deviating from the teachings herein. Further, in an embodiment, the controller 426 may connect with a remote computing system, such as a distributed or cloud based computing system for example.

In an embodiment, the controller 426 includes one or more processors 436 that are configured to execute computer instructions when executed on the processors 426 to process data and initiate operation of one or more components of scanner 400. The one or more processors 426 are coupled to memory 438 (e.g. random access memory, non-volatile memory, and/or read-only memory), a storage device 440 and a communications circuit 442. The communications circuit 442 may be configured to transmit and receive signals via wired or wireless communications mediums with external computing devices.

The controller 426 may include further components, such as but not limited to input/output (I/O) controllers or analog-to-digital (A/D) converters as is known in the art. In an embodiment, a power supply 444 (e.g. a battery) may be provided to supply electrical power to the controller 426, the depth cameras 416A, 416B, 416C, motor 420, encoder 421, IMU 430, and 2D camera 432.

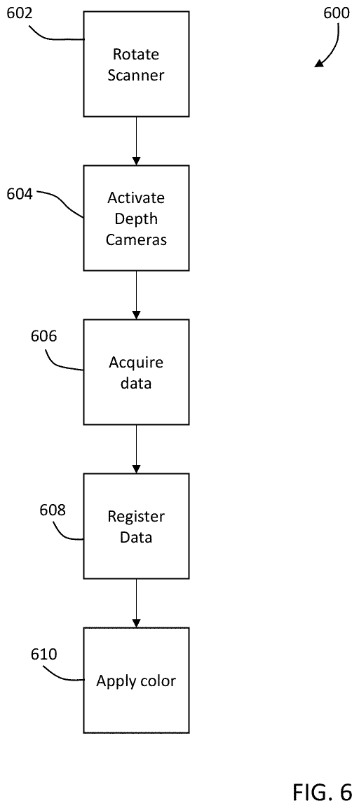

Controller 426 includes operation control methods embodied in application code shown in FIG. 6. These methods are embodied in computer instructions written to be executed by processor 436, typically in the form of software. The software can be encoded in any language. Furthermore, the software can be independent of other software or dependent upon other software, such as in the form of integrated software.

Referring to FIG. 6, a method 600 is shown for acquiring three dimensional coordinates of an environment. The method 600 begins in block 602 where rotation is initiated of the scanner 100, 400. In the exemplary embodiment, the scanner housing 102, 402 is by the motor 220, 420 at a speed of 30 Hz. The method 600 then proceeds to block 604 where the depth cameras 216A, 216B, 216C, 416A, 416B, 416C are activated. The activation of the depth cameras includes the acquisition of a color image of the environment within the field of view of each depth camera. The activation of the depth cameras further includes acquiring depth information for each pixel of the acquired image.

The method 300 then proceeds to block 606 where images with depth information are acquired by each of the depth cameras. In an embodiment where the scanner 100, 400 is coupled to a fixture/tripod 300, the acquisition of the images with depth information may be performed in a single 360 rotation. In an embodiment where the scanner 100, 400 is carried through the environment, either by the operator using the handle 214 or using a mobile platform, the scanner housing 102, 402 may rotate on a continuous, periodic or aperiodic basis. During the acquisition of the data in block 606, the scanner 100, 400 associates the rotation angle (from rotary encoder 421) and any movement with the acquired images. In an embodiment, movement data may be acquired by IMU 430. In an embodiment, the acquired images, the rotational angle, and the movement data may include a time stamp that allows the images, rotational angle and movement data to be associated after the scanning has been completed. The set of data, meaning the three images with depth information, the rotational angle, and the time stamps, may collectively be referred to as a frame.

Once the data has been acquired, the method 600 then proceeds to block 608 where the data is registered to generate a point cloud of three-dimensional coordinate data in a common coordinate frame of reference. In an embodiment, this step includes extracting the depth information from each other images and associating the depth information with a rotational angle. In an embodiment, the associating of the depth information with a rotational angle is based at least in part on a time stamp data. In an embodiment where the scanner 100, 400 is moved through the environment, the registration is further based at least in part on movement data. The movement data may include translational and/or rotational movement of the scanner 100, 400. In an embodiment, the movement data may include measurement data from the IMU 421. In another embodiment, movement data may be generated using 2D image data from 2D camera 432 that is used with a methodology, such as simultaneous localization and mapping (e.g visual SLAM) for example, to determine the position and orientation of the scanner 100, 400.

In an embodiment, the images acquired by the depth cameras are used for tracking the position of the scanner 100, 400 using simultaneous localization and measurement. In an embodiment, a three-dimensional occupancy grid map is generated with the IMU 421 data being used as a further localization constraint.

In an embodiment, the movement data is used as an input or a constraint into a registration method, such as iterative closest point (ICP) methods for example.

In an embodiment, the controller 226, 426 includes a user interface having a display that is viewable by the operator. In an embodiment, the acquired three-dimensional coordinate data is displayed on the display to provide the user with a visual indication of the areas that have been scanned. In an embodiment, during the acquisition step, only a portion of the acquired data is registered and displayed, such as every other acquired image frame for example, to reduce on computation requirements

It should be appreciated that in some embodiments, due to the position of the operator during acquisition of the three-dimensional coordinates, the acquired three-dimensional coordinate data may include data points on the operator. It should be appreciated that these data points may be undesired and are filtered from the point cloud. In an embodiment, the method 600 filters the three-dimensional coordinates to remove points that are too close to the scanner 100, 400, by removing points within a predetermined field of view (e.g. directly behind the scanner), or a combination of the foregoing.

With the three-dimensional coordinate data generated, the method 600 then proceeds to optional block 610 where color information from the images acquired by the depth cameras is mapped onto, or associated with, the three-dimensional coordinate data.

The term “about” is intended to include the degree of error associated with measurement of the particular quantity based upon the equipment available at the time of filing the application. For example, “about” can include a range of ±8% or 5%, or 2% of a given value.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A three dimensional coordinate measurement device comprising:
a housing having a first axis and a second axis;
a first depth camera coupled to the housing, the first depth camera having a first optical axis aligned with the first axis;
a second depth camera coupled to the housing, the second depth camera having a second optical axis disposed on a first angle relative to the first axis;
a third depth camera coupled to the housing, the third depth camera having a third optical axis disposed on a second angle relative to the first axis, the second angle being different than the first angle; and
a rotational device coupled to rotate the housing about the second axis.

2. The device of claim 1, further comprising one or more processors operably coupled to the first depth camera, the second depth camera, and the third depth camera, the one or more processors being configured to receive a first image data from the first depth camera, a second image data from the second depth camera, and a third image data from the third depth camera.

3. The device of claim 2, wherein the first image data, the second image data, and the third image data each include an image and distance data associated with the image.

4. The device of claim 2, further comprising an encoder operably coupled to the motor and configured transmit an angle signal to the one or more processors indicating an angle of the motor about the second axis.

5. The device of claim 4, wherein the one or more processors are operable to determine three dimensional coordinates of a plurality of points on surfaces in an environment based at least in part on the first image data, the second image data, the third image data, and the angle signal.

6. The device of claim 5, wherein the one or more processors are operable to assign color data to each of the three-dimensional coordinates based on at least one of the first image data, the second image data and the third image data.

7. The device of claim 5, wherein the one or more processors are operable to register the three dimensional coordinates into a common coordinate frame of reference.

8. The device of claim 7, wherein the registration is performed based at least in part using simultaneous localization and mapping.

9. The device of claim 8, further comprising an inertial measurement unit operably coupled to the housing, wherein the registration is further based at least in part on one or more movement signals from the inertial measurement unit.

10. The device of claim 1, wherein the first depth camera, the second depth camera, and the third depth camera measure distance based at least in part on the time of flight of light.

11. The device of claim 1, wherein the first depth camera, the second depth camera, and the third depth camera each include a first photosensitive array and a second photosensitive array, the distance measured by the first depth camera, the second depth camera, and the third depth camera is based at least in part on images acquired by the first photosensitive array, the second photosensitive array, and a baseline distance between the first photosensitive array and the second photosensitive array.

12. The device of claim 1, wherein the first depth camera, the second depth camera, and the third depth camera measure distance based on a projection of a structure light pattern.

13. A method of measuring three-dimensional coordinates in the environment, the method comprising:
rotating a scanning device about a first axis, the scanning device having a first depth camera, a second depth camera, and a third depth camera, the first depth camera having a first optical axis aligned with a second axis, the second depth camera having a second optical axis disposed on a first angle relative to the second axis, and the third depth camera having a third optical axis disposed on a second angle relative to the second axis;
acquiring a first image data with the first depth camera;
acquiring a second image data with the second depth camera;
acquiring a third image data with the third depth camera; and
determining three-dimensional coordinates of points on surfaces in the environment based at least in part on the first image data, the second image data, the third image data, and an angle of the scanning device about the first axis.

14. The method of claim 13, wherein the acquisition of the first image data, second image data, and third image data are performed simultaneously.

15. The method of claim 14, recording a time data when the first image data, second image data, and third image data are acquired.

16. The method of claim 13, further comprising registering the three-dimensional coordinates in a common coordinate frame of reference.

17. The method of claim 16, wherein the registration of the three-dimensional coordinates is based at least in part on a movement signal from an inertial measurement unit operably coupled to the scanning device.

18. The method of claim 13, further comprising assigning a color to each of the three-dimensional coordinates based at least in part on one of the first image data, the second image data, and the third image data.

19. The method of claim 13, wherein the first image data, the second image data, and the third image data is based at least in part on a time of flight of light.

20. The method of claim 13, further comprising projecting a structured light pattern with each of the first depth camera, the second depth camera, and the third depth camera.
